(19) United States
(12) Patent Application Publication
(10) Pub. No.: US 2026/0202534 A1
(43) Pub. Date: Jul. 16, 2026

(54) SPATIAL WINDOWING FOR TARGET DETECTION SYSTEMS

(71) Applicant: CHAOS INDUSTRIES, INC., Hermosa Beach, CA (US)

(72) Inventors: James WILSON, Hermosa Beach, CA (US); Mark Jeffrey ROSKER, Falls Church, VA (US); Justin HODIAK, El Cajon, CA (US); Hadis HELLESEN, Hermosa Beach, CA (US); Harry Bourne MARR, JR., Manhattan Beach, CA (US)

(21) Appl. No.: 19/019,282

(22) Filed: Jan. 13, 2025

(51) Int. Cl. G01S 13/48; G01S 13/00; G01S 13/46

(52) U.S. Cl. CPC G01S 13/48; G01S 13/003; G01S 2013/462

(57) ABSTRACT

A system may include a first RF receiver configured to have a first directionality for receiving a first RF signal in a first spatial window that contains a target and a second RF receiver configured to have a second directionality for receiving a second RF signal in a second spatial window that also contains the target. A programmable processor can perform operations including determining an overlapping spatial window of the first spatial window and the second spatial window and determining a location of the target within the overlapping spatial window based on a correlation that utilizes the first RF signal with a reduced time window based on the overlapping spatial window.

### DESCRIPTION OF THE RELATED ART

Radar systems are utilized to detect and track targets based on radio frequency (RF) signals received from the target (e.g., reflected from an RF source or emitted by the target). Radar systems can be located as static installations with large receiver arrays and antennas, located on trucks or other vehicles, etc. The range of such radar systems can be approximately 1-10 km, or more, depending on the application, size of the system, etc.

### SUMMARY

In some aspects, the techniques described herein relate to a system including: a first RF receiver configured to have a first directionality for receiving a first RF signal in a first spatial window that contains a target; a second RF receiver configured to have a second directionality for receiving a second RF signal in a second spatial window that also contains the target; at least one programmable processor; and a non-transitory machine-readable medium storing instructions which, when executed by the at least one programmable processor, cause the at least one programmable processor to perform operations including: determining an overlapping spatial window of the first spatial window and the second spatial window; and determining a location of the target within the overlapping spatial window based on a correlation that utilizes the first RF signal with a reduced time window based on the overlapping spatial window. Claims illustrating general system

In some aspects, the techniques described herein relate to a system, wherein the system includes at least 10 RF receivers, in addition to the first RF receiver and the second RF receiver, and the correlation is based on corresponding RF signals received at the at least 10 RF receivers.

In some aspects, the techniques described herein relate to a system, wherein the first RF receiver and second RF receiver are connected via a communication network.

In some aspects, the techniques described herein relate to a system, wherein the correlation is an autocorrelation between the first RF signal and a first direct signal from a reference transmitter, the correlation providing a correlation peak giving range data of the target from the first RF receiver and also a frequency shift of the correlation peak giving speed data of the target.

In some aspects, the techniques described herein relate to a system, wherein the first spatial window and the second spatial window are based at least on a range, azimuth, or elevation.

In some aspects, the techniques described herein relate to a system, the operations further including changing a first direction of the first RF receiver or a second direction of the second RF receiver to change the overlapping spatial window and sweep over a region of interest to generate multiple overlapping spatial windows.

In some aspects, the techniques described herein relate to a system, the operations further including performing correlations in the multiple overlapping spatial windows to determine the location.

In some aspects, the techniques described herein relate to a system, the operations further including performing parallel correlations for two or more of the multiple overlapping spatial windows.

In some aspects, the techniques described herein relate to a system, the operations further including: determining an initial state of the target based on the first RF signal and the second RF signal, wherein the first RF signal and second RF signal used to determine the initial state are not localized to the overlapping spatial window; and determining a subsequent overlapping spatial window for a subsequent state of the target by excluding spatial information or frequency information from the first RF signal and the second RF signal that does not correspond to a window around the initial state of the target.

In some aspects, the techniques described herein relate to a system, wherein the initial state includes an initial location of the target or an initial speed of the target and the window is at least based on a location window around the initial location or a speed window around the initial speed of the target.

In some aspects, the techniques described herein relate to a system, wherein the first RF signal has encoded spatial information and frequency information, the operations further including: determining the spatial information and the frequency information of the first RF signal, where the frequency information includes a frequency shift based on a target speed; and excluding a portion of the spatial information based on the portion having frequency information outside a frequency window around the frequency shift, when determining the location of the target.

In some aspects, the techniques described herein relate to a system, wherein the reduced time window is further based on a distance of the overlapping spatial window from the first RF receiver.

In some aspects, the techniques described herein relate to a system, the operations further including determining a speed of the target based on a doppler shift of a frequency location of a correlation peak in the correlation.

In some aspects, the techniques described herein relate to a system, the operations further including determining a range of the target based on a spatial location of a correlation peak in the correlation.

In some aspects, the techniques described herein relate to a system, wherein an RF signal to the first RF receiver includes a direct signal from a reference transmitter, the first RF signal reflected from the target, and a multipath signal resulting from other reflections of RF signals originating from the reference transmitter.

In some aspects, the techniques described herein relate to a system, wherein the reduced time window reduces a contribution of the multipath signal to the correlation.

In some aspects, the techniques described herein relate to a system, the operations further including filtering the first RF signal or the second RF signal with a finite impulse response (FIR) filter to reduce direct signal interference from a transmitter transmits a reference RF signal to the target that reflects to generate the first RF signal and the second RF signal.

In some aspects, the techniques described herein relate to a system, wherein the FIR filter is a spatial filter.

In some aspects, the techniques described herein relate to a system, wherein the FIR filter is a temporal filter.

In some aspects, the techniques described herein relate to a system, the operations further including thumbtack autocorrelation.

In some aspects, the techniques described herein relate to a system, the operations further including subtracting delayed replicas of the RF reference signal from the first RF signal and the second RF signal.

In some aspects, the techniques described herein relate to a system, the operations further including matched filtering.

In some aspects, the techniques described herein relate to a system, the operations further including remodulation of a reference signal.

In some aspects, the techniques described herein relate to a system, further including a dedicated transmitter configured to transmit a dedicated RF signal to the target, with a reflected dedicated RF signal that is detected by the first RF receiver or the second RF receiver and increases an amplitude of the correlation.

In some aspects, the techniques described herein relate to a system, further including a reference receiver configured to receive a reference RF signal directly from a reference transmitter that transmits the reference RF signal to the target that reflects to generate the first RF signal and the second RF signal.

In some aspects, the techniques described herein relate to a system, wherein the reference receiver is configured to receive the reference RF signal omnidirectionally.

In some aspects, the techniques described herein relate to a system, wherein the reference receiver is configured to have a reference directionality in receiving the reference RF signal.

In some aspects, the techniques described herein relate to a system including: two or more RF receivers, each configured to receive an RF signal, the RF receivers configured to have a directionality for receiving the RF signal and time synchronized to a fraction of a wavelength with the other receivers using a calibration routine and a multi-node two-way time transfer routine; at least one programmable processor; and a non-transitory machine-readable medium storing instructions which, when executed by the at least one programmable processor, cause the at least one programmable processor to perform operations including: determining a location of a target by multi-lateration using a time or phase difference of arrival interferometry technique from the two or more RF receivers.

In some aspects, the techniques described herein relate to a system, wherein the fraction is 1/10th of the wavelength or less.

In some aspects, the techniques described herein relate to a system, the operations further including combining the determined time difference or phase difference of arrival from the two or more RF receivers to determine the location.

In some aspects, the techniques described herein relate to a non-transitory, machine-readable medium storing instructions which, when executed by at least one programmable processor, cause the at least one programmable processor to perform operations including: receiving, from a first RF receiver having a first directionality, a first RF signal from a first spatial window that contains a target; receiving, from a second RF receiver having a second directionality, a second RF signal in a second spatial window that also contains the target; determining an overlapping spatial window of the first spatial window and the second spatial window; and determining a location of the target within the overlapping spatial window based on a correlation between first RF signal and the second RF signal, wherein the location is based on a correlation strength and known locations of the first RF receiver and the second RF receiver.

In some aspects, the techniques described herein relate to a machine-readable medium, wherein the correlation is an autocorrelation between the first RF signal and a first direct signal from a reference transmitter, the operations further including: providing, with the autocorrelation, a correlation peak giving range data of the target from the first RF receiver and also a frequency shift of the correlation peak giving speed data of the target.

In some aspects, the techniques described herein relate to a machine-readable medium, the operations further including: changing a first direction of the first RF receiver or a second direction of the second RF receiver to change the overlapping spatial window and sweep over a region of interest to generate multiple overlapping spatial windows.

In some aspects, the techniques described herein relate to a machine-readable medium, the operations further including: determining an initial state of the target based on the first RF signal and the second RF signal, wherein the first RF signal and second RF signal used to determine the initial state are not localized to the overlapping spatial window; and determining a subsequent overlapping spatial window for a subsequent state of the target by excluding spatial information or frequency information from the first RF signal and the second RF signal that does not correspond to a window around the initial state of the target.

In some aspects, the techniques described herein relate to a machine-readable medium, wherein the first RF signal has encoded spatial information and frequency information, the operations further including: determining the spatial information and the frequency information of the first RF signal, where the frequency information includes a frequency shift based on a target speed; and excluding a portion of the spatial information based on the portion having frequency information outside a frequency window around the frequency shift, when determining the location of the target.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also contemplated that may include one or more processors and one or more memories coupled to the one or more processors. A memory, which can include a computer-readable storage medium, may include, encode, store, or the like, one or more programs that cause one or more processors to perform one or more of the operations described herein. Computer implemented methods consistent with one or more implementations of the current subject matter can be implemented by one or more data processors residing in a single computing system or across multiple computing systems. Such multiple computing systems can be connected and can exchange data and/or commands or other instructions or the like via one or more connections, including but not limited to a connection over a network (e.g., the internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to particular implementations, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations.

In the drawings,

FIG. 1 is a diagram illustrating a system utilizing at least two receivers for locating a target in accordance with certain aspects of the present disclosure.

FIG. 2A is a diagram illustrating the correlation of RF signals received at two receivers for determining a target location in accordance with certain aspects of the present disclosure.

FIG. 2B is a diagram illustrating improvements of the signal-to-noise ratio by spatial windowing and filtering in accordance with certain aspects of the present disclosure.

FIG. 2C is a block diagram of an adaptive filter in accordance with certain aspects of the present disclosure.

FIG. 3 is a diagram illustrating wide-range scanning to generate multiple overlapping spatial windows in accordance with certain aspects of the present disclosure.

FIG. 4A is a diagram showing an initial target state as determined in a large spatial window in accordance with certain aspects of the present disclosure.

FIG. 4B is a diagram showing a subsequent target state as determined based on an initial target state in accordance with certain aspects of the present disclosure.

FIG. 5 is a diagram illustrating a system that includes a dedicated transmitter in accordance with certain aspects of the present disclosure.

FIG. 6 is a diagram illustrating a system that includes a reference receiver in accordance with certain aspects of the present disclosure.

### DETAILED DESCRIPTION

The present disclosure provides systems, methods, and computer programs that improve the detection ability and efficiency of radar systems. One primary way in which various embodiments perform this is by reducing the amount of data that needs to be processed to determine a target location from received RF signals. The reduction can be achieved by limiting the analysis to received RF signals in a particular time window (which also corresponds to a spatial window as explained herein) and/or having a certain frequency window. Implementing either or both of these features can dramatically reduce the number of computational operations required to determine a target's position. As such, the detection sensitivity can be increased and can therefore allow smaller detection units due to reduced physical processing hardware or target detection at longer ranges due to increased signal-to-noise (SNR).

Another benefit of the present disclosure is providing embodiments that use receivers only (e.g., not having high-power transmitters as with conventional radar systems). The detectability of the system is greatly reduced as there are no RF emissions (or at least no high-power RF emissions) that can be detected by other systems.

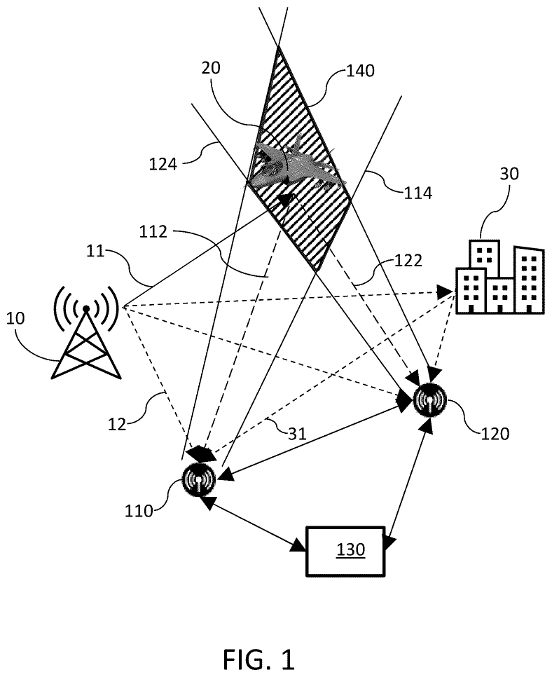

FIG. 1 is a diagram illustrating a system utilizing at least two receivers for locating a target. In this example, the initial RF signal 11 can be generated by a reference transmitter 10, which may be a radio tower (e.g., for a commercial radio station, cellular tower, etc.), other (e.g., enemy) radar transmitters, or other “illuminators of opportunity” that are not necessarily part of any particular embodiment of the disclosed detection systems. In this example embodiment, reference transmitter 10 is depicted as emitting omni-directional RF transmission. As used herein, the term “reference transmitter” refers to a source of RF emissions that may not be a part of the detection system. This is as opposed to embodiments with a “dedicated transmitter,” which can intentionally provide additional RF emissions towards the target such as for increasing received RF signals. FIG. 1 shows examples of RF signals emitted from reference transmitter 10 and reflecting off target 20 and structures 30, before reaching first RF receiver 110 and second RF receiver 120. In some embodiments, the receiver can be polarization-matched (with reference transmitter 10), single-channel antennas.

In particular, the depicted example system can include first RF receiver 110 configured to have a first directionality for receiving a first RF signal 112 in a first spatial window 114 that can contain target 20. Similarly, the system can include second RF receiver 120 configured to have a second directionality for receiving second RF signal 122 in second spatial window 124 that also contains target 20. When referring to the spatial windows, this generally means a cone or other region of detection based on the particular directionality of the receiver. The directionality of the receivers can be established based on parameters that allow detection in a particular region of space. In some embodiments, first spatial window 114 and second spatial window 124 can be based at least on a range, azimuth, or elevation. These parameters can be relative to a reference point which (may) be either the first receiver or the second receiver, but can also be another reference (e.g., range from a known location such as a transmitter or observer, elevation above sea level, etc.).

As used herein, the term “directionality” refers to a receiver (or transmitter) having a restricted or preferred direction of detection (or emission) of RF signals. In this example, the preferred directions for the two receivers are pointed at target 20 as shown. Directional systems can utilize directed antennas, phased arrays, parabolic dishes, or other features that reduce RF signal reception/transmission from directions other than the preferred direction. As shown in the simplified illustration of FIG. 1, the directionality can be a cone or similar shape (e.g., a cone with angled sides 1, 5, 10, etc. degrees from its central axis). While the example of FIG. 1 shows a cone illustrated as definite solid lines, it should be understood that the directionality can, for example, include a fall-off where the signal reduction decreases steadily away from the preferred direction. In some embodiments, directionality can also be represented by main and side lobes that may be present in RF antennas. The directionality of the receivers can also be changed, for example, by pointing a dish in a different direction, changing filtering conditions to avoid or suppress signals from certain directions, etc.

As shown by the depicted lines in FIG. 1, an RF signal to the first RF receiver can include a first direct signal 12 from reference transmitter 10, first RF signal 112 reflected from target 20, and a multipath signal 31 resulting from other reflections of RF signals originating from the reference transmitter. Corresponding signals can also be received at second RF receiver 120.

The two (or more) receivers can be connected via a communication network (e.g., wired or wirelessly). For example, the communication network can be a high-frequency (e.g., 10-200 GHz, 25-200 GHz, 50-79 GHz, 60 GHz, etc.). The receiver can be connected to multiple other receivers to form a mesh network, which may provide redundant communication paths. In some embodiments, receivers can perform initial data processing and filtering to reduce the volume of data that needs to be transmitted. Only relevant information, such as target detections and track updates, can be shared with other computing systems. Some embodiments, can implement a hierarchical network structure where intermediate nodes (e.g., receivers or other processing devices) aggregate and process data from multiple receivers before forwarding summarized results to another (e.g., centralized) computer. In some embodiments, transmitting of data can happen only when significant events occur (e.g., detection of a new target, significant change in target behavior) rather than continuous streaming.

Receivers can also be in communication with computing system 130 that can process the data related to receipt of first RF signal 112 and second RF signal 122. Such a computing system can include at least one programmable processor and a non-transitory machine-readable medium (e.g., physical computer memory) storing instructions (e.g., computer code) which, when executed by the at least one programmable processor can cause the programmable processor(s) to perform computer operations as described herein. While computing system 130 is depicted as a separate element, in some embodiments, computing system can be integrated into one or more of the receivers.

In some embodiments, the operations can include determining overlapping spatial window 140 of the first spatial window 114 and second spatial window 124. Overlapping spatial window 140 is depicted in FIG. 1 by the shaded region where first spatial window 114 and second spatial window 124 overlap. While the simplified illustration depicts a two-dimensional region, it is understood that in practice that overlapping spatial window 140 can be a three-dimensional volume (e.g., based on corresponding three-dimensional volumes of the two receiver directionalities). It can immediately be seen that by processing data based on overlapping spatial window 140, that other data (e.g., from reflections off structures 30) can be reduced or eliminated.

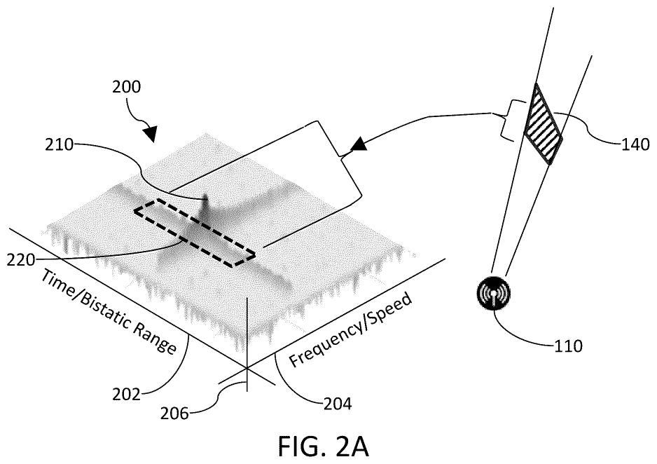

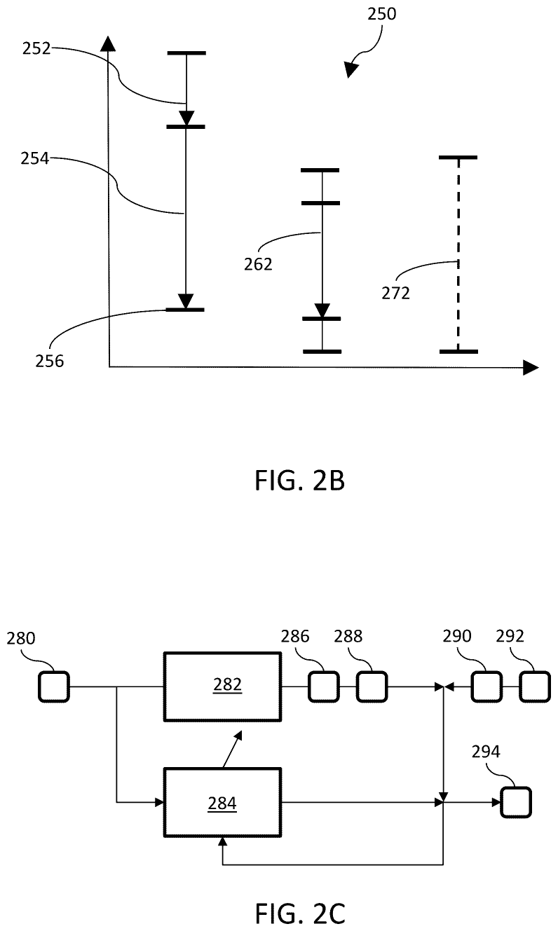

To determine the location of target 20, correlation methods can be utilized that can provide information about the range of target 20 from a receiver. Very generally, the target location is related to (e.g., correlated with) a time lag in the RF signals that reach a receiver. Performing the correlation can include calculations over a time window representing a large number of possible time lags, including those that would result from locations outside the overlapping spatial window. However, limiting the analysis to those of time lags corresponding to the overlapping spatial window, as explained with reference to FIG. 2A, the computations can be greatly reduced. As such, the operations can also include determining a location of target 20 within overlapping spatial window 140 based on a correlation that utilizes first RF signal 112 with a reduced time window based on overlapping spatial window 140.

While two receivers are shown in the simplified example of FIG. 1, the system can be extended, and benefit from, having additional receivers. For example, in some embodiments, the system can include one, two, five, at least 10, at least 100, (or more) RF receivers, in addition to first RF receiver 110 and second RF receiver 120. Then, for example when there are at least 10 RF receivers, the correlation can be based on corresponding RF signals received at the at least 10 RF receivers. For example, with additional receivers, overlapping spatial window 140 can be reduced even further in size.

FIG. 2A is a diagram illustrating the correlation of RF signals received at two receivers for determining a target location. As shown in FIG. 2A, in some embodiments, correlation 200 can be an autocorrelation (and can also be referred to as a complex ambiguity function, or cross-correlation) between first RF signal 112 and first direct signal 12 from reference transmitter 10. Correlation 200 can include correlation peak 210 giving, for example, range data (e.g., a bistatic range) of target 20 from first RF receiver 110 and also a frequency shift (e.g., a doppler shift) of correlation peak 210 giving speed data of target 20 relative to first RF receiver 110. Correlation 200 is depicted as having a temporal axis 202, frequency axis 204, and an amplitude axis 206. The example correlation also depicts a noise level with correlation peak 210 at a given spatial location and frequency. The orthogonal bands represent sidebands from the frequency and temporal position of the correlation peak. With such correlation data, a range of the target can be determined based on a spatial location of the peak in the correlation. Similarly, the speed of the target can be determined based on a doppler shift of a frequency location of the peak in the correlation. One example of a correlation function that can generate correlation 200 can be written as:

$$χ ( τ , {f}_{D} ) = {\int }_{- ∞}^{+ ∞} {s}_{surv} ( t ) {s}_{ref}^{⋆} ( t - τ ) {e}^{- j 2 π {f}_{D} t} dt , \qquad ( Eq . 1 )$$

where χ is the correlation amplitude, τ is a particular time lag in the signal data (corresponding to a value along temporal axis 202), f_{D} is the frequency domain variable (or value along frequency axis 204). The two correlated functions are Sₛᵤᵣᵥ, which is the RF signal at the receiver after reflecting off the target and S_{ref} (which is the direct RF signal at the receiver that is received a time τ earlier, also referred to herein as the lag time or difference in arrival times). The general expression of Eq. 1 shows it integrated over all possible time lags times (i.e., over all available received signal data). With the correlation peak found corresponding to a particular lag time, this can provide a bistatic range between the transmitter, target, and receiver. The bistatic range can then be used to establish a range ellipsoid. With similar measurements from other receivers, the position of the target on this ellipsoid can be determined for a precise target location. The above discussion is also appliable at any given frequency (f_{D} in Eq. 1). As such, the speed information from the receivers (based on the determined doppler shifts or f_{D}) can be used to determine a velocity vector of the target.

The integration in Eq. 1 can be modified by, instead of integrating over all possible time lags given the available RF signal data, changing the limits of integration to be over time lags corresponding to the overlapping spatial window (i.e., excluding some of the RF signal data that does not correspond the overlapping spatial window). This is depicted in FIG. 2A by the reduced window 220 along the temporal axis 202. The window is depicted as having a finite frequency width to represent the particular f_{D} or a fairly narrow frequency band. This temporal windowing changes the limits of integration from, for example, being over N values (N=the entire size of the RF signal data vector) to M values (M<N) for RF signal data for M time lags that correspond to the overlapping spatial window. Because M is smaller (and in some embodiments can be much smaller, e.g., orders of magnitude), the number of computations to determine the correlation peak can be greatly reduced.

Since the number of operations per correlation scales exponentially (e.g., N²) with the number of samples (e.g., N) and the number of correlations scale linearly (e.g., D) with the number of frequencies (e.g., doppler search bins, f_{D}), prior to utilizing the disclosed techniques, a brute-force correlation of RF signal data would be an O(N²) operation, or an N log(N) operation using the Fourier transforms of the RF signal data. However, the above technique shows that the number of operations can be greatly reduced (e.g., to M log(M)). Furthermore, in some embodiments, limiting the frequency ranges (e.g., utilizing doppler search bins for possible target speeds as described further herein) can also cause a further reduction. Accordingly, in various embodiments, temporal axis 202 (time/range) and/or frequency axis 204 (frequency/speed) (see, e.g., FIG. 2A) can be truncated to reduce the search space and thus the number of calculations/operations. The example of Eq. 1 is an integral of time −inf to +inf, which in practice is limited to the coherence time of the target and represented here as N samples. This truncation can be done for each doppler bin, which can create a matrix of D doppler bins×N time length. In this way, either D or N can be limited to reduce the needed computations.

The benefits of this reduction in computational requirements can include allowing physically smaller receivers, increased sample sizes but within smaller frequency windows (resulting in improved signal-to-noise), among others. As an additional benefit, the reduced time window can reduce the contribution of the multipath signal (e.g., the small peaks seen off the two correlation bands) to the correlation. Such reductions can improve accuracy by reducing “noise” in the correlation.

In some embodiments, further refinement of the reduced time window can be based on the distance of the overlapping spatial window from the receiver. Because signal strength decreases with range, for overlapping spatial windows that are closer to the receiver it can be expected that the RF signals are stronger than those from overlapping spatial windows that are further away. Accordingly, an even smaller integration window can be utilized while still maintaining an acceptable SNR. Thus, some embodiments can include utilizing a reduced time window further based on a distance of the overlapping spatial window from the first receiver. As one example, if a first overlapping spatial window was at half the distance as a second overlapping spatial window then, assuming an inverse-square falloff of signal strength, the reduced time window for the first overlapping spatial window could be one-fourth the size of that used for the second overlapping spatial window, as this would presumably provide similar SNR.

FIG. 2B is a diagram illustrating improvements of the signal-to-noise ratio by spatial windowing and filtering. The depicted plot 250 shows examples of powers of various RF signal sources before and after implementation of some of the techniques described herein. Direct signal power reduction 252 can be due to the spatial filtering described above and herein, as the direct signal does not originate within the overlapping spatial window. Direct signal interference (DSI) reduction 254 can also be due to, in some embodiments, filtering the first RF signal or the second RF signal with a finite impulse response (FIR) filter to reduce direct signal interference from a transmitter (e.g., reference transmitter 10). The FIR filter can be a spatial filter or a temporal filter. An example of an FIR filter is depicted in FIG. 2C. Combined with the spatial window reduction 256 based on the techniques described herein, the effective direct signal power 258 can be reduced substantially.

In some embodiments, other filtering can include thumbtack autocorrelation that can be utilized for filtering with certain digital waveforms (e.g., as Advanced Television Systems Committee version 3 (ATSC3) used in North America, Digital Terrestrial Video Broadcasts (DTVB) used in Europe, etc.).

In some embodiments, other filtering can include subtracting delayed replicas of the RF reference signal from the first RF signal and the second RF signal.

In some embodiments, other filtering can include matched filtering.

In some embodiments, other filtering can include remodulation of a reference signal. This can include, for example, demodulating the transmitted waveform all the way through the error correction resulting in the digital output expected (e.g., digital video can be noise free or not available, it doesn't degrade like analog video or audio with static in the output). This data output can then be remodulated with the same process as the original transmission, free of any of the multipath reflections or noise that is picked up in the original. In this way, the output can be a pure reference to use in the correlation.

Similarly, the thermal noise power reduction 262 can also be due to the spatial windowing technique described above. Plot 250 also shows that the target echo power 272 (e.g., the first RF signal) is shown in comparison to the effective direct signal power and the effective thermal noise power. With the disclosed techniques, the target echo power can dominate over the direct signal power and the thermal noise power, allowing for reduced computational requirements (integration times and physical memory) and/or hardware requirements (processor or antenna sizes).

FIG. 2C is a block diagram of an adaptive filter. In some embodiments, filtering can be utilized to minimize the error between an estimate of a signal (the echo) and the reference signal with an optimal set of filter coefficients. FIG. 2C is an embodiment showing filtering of a raw signal 280 provided to channel 282 with corresponding adaptive filter 284. The output of channel 282 can include direct signal 286 and interference (or multipath) signal 288. This can be combined with echo signal 290 and noise 292. By combining with the output of adaptive filter 284, filtered signal 294 can be obtained.

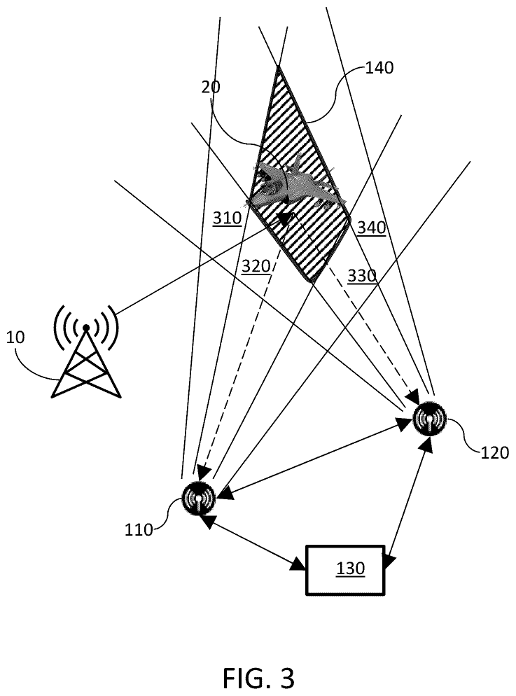

FIG. 3 is a diagram illustrating wide-range scanning to generate multiple overlapping spatial windows. As previously mentioned, receivers with directionality can be controlled to receive data from different directions (e.g., by turning a directional antenna). Such capability can be realized by changing a first direction (e.g., where the first receiver is pointing) of the first RF receiver 110 and/or a second direction (e.g., where the second receiver is pointing) of the second RF receiver 120 to change the overlapping spatial window 140 and sweep over a region of interest to generate multiple overlapping spatial windows. In the example of FIG. 3, other directions for the receivers are depicted and examples of some of the corresponding overlapping spatial windows 310, 320, 330, and 340 are shown.

The system can then perform correlations in the multiple overlapping spatial windows to determine the location of the target. Such correlations can be performed in series (e.g., establishing one spatial window, correlating, establishing another, correlating again, and so on).

In other embodiments, the system can perform parallel correlations for two or more of the multiple overlapping spatial windows. For example, data can be rapidly acquired by the receivers from changing their directions, and the correlation calculations performed in parallel for multiple spatial windows.

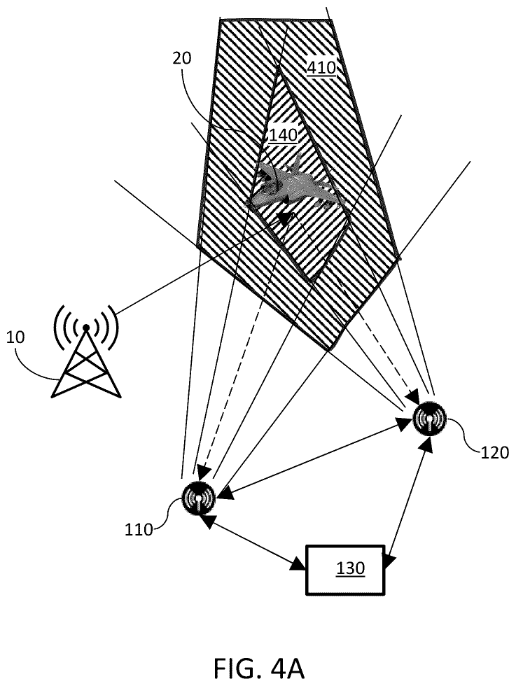

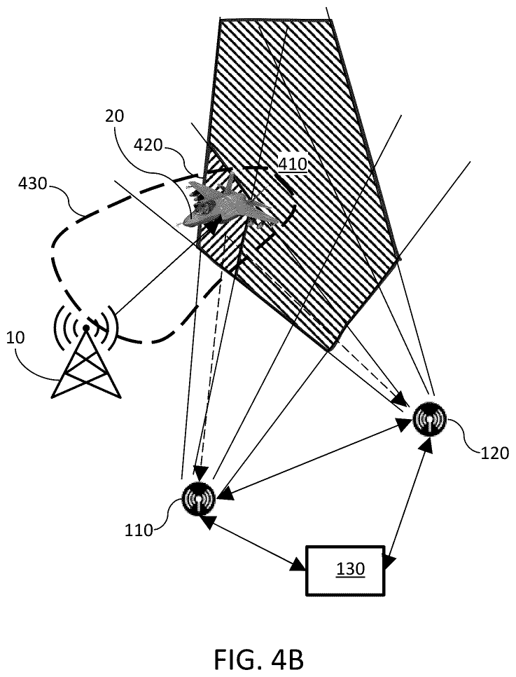

FIG. 4A is a diagram showing an initial target state as determined in a large spatial window. In some embodiments, the system can do a fast, wide scan over a large spatial window 410 (but still spatially limited to an extent, such as by methods described herein) to get an approximate target location (e.g., but one having a lower SNR), then perform a narrower scan around that approximate location to precisely locate the target. For example, the system can determine an initial state of the target (e.g., an initial location or an initial speed) based on first RF signal and second RF signal, but where the first RF signal and second RF signal used to determine the initial state are not localized to overlapping spatial window 140 (e.g., includes other regions in large spatial window 410 where the target might be). Such an initial determination can be performed by, for example, sweeping, changing lobe sizes, etc. to generate multiple overlapping spatial windows similarly to that described with reference to FIG. 3. An example of this large spatial window 410 is shown FIG. 4A.

FIG. 4B is a diagram showing a subsequent target state as determined based on an initial target state. With the approximate location known (e.g., in large spatial window 410 as opposed to other spatial windows outside it), the system can determine a subsequent overlapping spatial window 420 for a subsequent state (e.g., position and/or velocity) of the target by excluding spatial information or frequency information from the first RF signal (i.e., the RF signal at the first RF receiver at this subsequent time) and the second RF signal (i.e., the RF signal at the second RF receiver at this subsequent time) that does not correspond to a window around the initial state of the target (e.g., a location window 430 defining a region around the initial location and/or a speed window (not depicted in FIG. 4B as this is a window in frequency space, as described above). The exclusion of spatial information can be seen from FIG. 4B where most of large spatial window 410 is not utilized because, based on the initial state of the target (e.g., its position and velocity), it is not expected to be in certain windows (e.g., behind or greatly above or below the initial estimated location). Such exclusions can further speed processing efficiency when tracking a target by making smart assumptions about subsequent target conditions. In some embodiments, if acquisition is lost, the scan can be widened to reacquire the target.

While the above example relates to narrowing the overlapping spatial window, similar binning or data exclusion techniques can be applied to a frequency window and further refine/speed up target tracking. For example, because the first RF signal can have encoded spatial information and frequency information, the system can determine the spatial information and the frequency information of the first RF signal, where the frequency information includes a frequency shift based on a target speed (e.g., the doppler shift). In a subsequent analysis, the system can therefore be configured to exclude data that would likely not need analysis. For example, excluding very low frequency shifts due to very low speeds, such as below a stall speed of an aircraft, or very high speeds outside of the aircraft's capabilities. Given such a frequency window, and knowing that this defines an effective velocity window, the possible location of the target in the subsequent acquisition can be restricted to a more finite volume. As such, the system can also exclude a portion of the spatial information based on the portion having frequency information outside a frequency window around the frequency shift, when determining the location of the target. For example, if based on the target's current speed it could only go 10 meters by the next acquisition, then the integration window (representing possible spatial locations) can be limited to the time lag window based on that possible 10 meter travel.

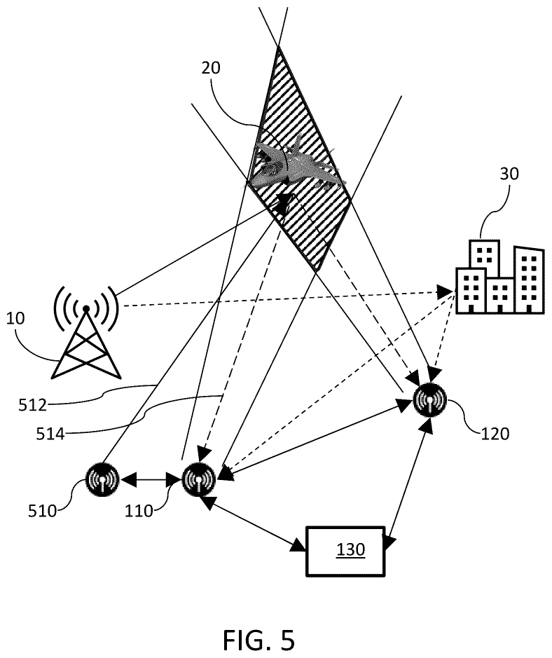

FIG. 5 is a diagram illustrating a system that includes a dedicated transmitter 510. In some embodiments, dedicated transmitter 510 can be configured to transmit a dedicated RF signal 512 to target 20. The reflected dedicated RF signal 514 can be detected by first RF receiver 110 or second RF receiver 120 and can therefore increase the amplitude of the correlation(s). Dedicated transmitter 510 can be in network communication with the receivers and/or computing system and be similarly time-synchronized. As such, knowing when dedicated RF signal 512 was emitted, the system can then perform additional calculations knowing the time-of-flight between emission, reflection, and detection. Dedicated transmitter 510 can be coherent with reference transmitter 10 (e.g., have the same frequency, phase, etc.) or can be distinguishable from reference transmitter 10 by virtue of having a different frequency, phase, etc. While the dedicated transmitter 510 can enhance SNR, it can also be used in environments lacking reference transmitters (e.g., in remote locations).

In some embodiments, the transmitter(s) can employ various spectral and temporal methods to maintain a reduced RF signature. Various embodiments can include, for example, frequency hopping a narrow instantaneous bandwidth across a large RF bandwidth, with the hopping pattern known amongst the transmitter and receivers; spread spectrum techniques that take a relatively narrow signal and spread it by multiplying it by a wideband, noise-like signal, reducing the signal power density while maintaining a high SNR after de-spreading at the receivers; time reversal techniques that apply a pre-conditioning to the transmitting signal such that it matches the complex conjugate of the channel and thus arrives arrived in time and phase at the receiver, etc.

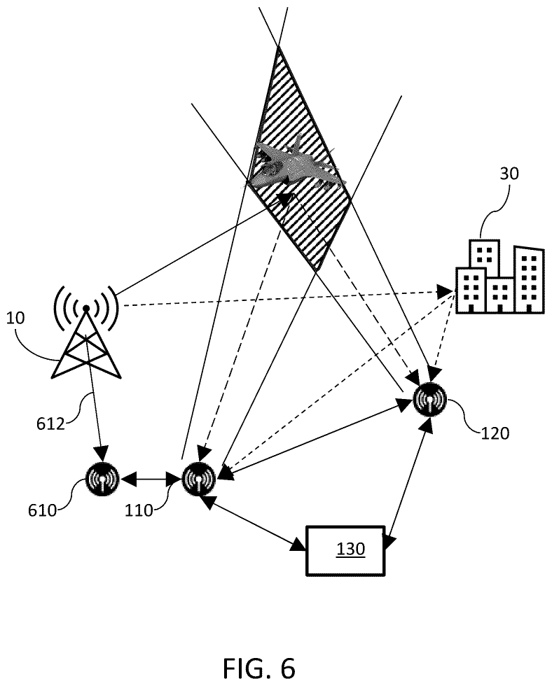

FIG. 6 is a diagram illustrating a system that includes a reference receiver. Some embodiments of the disclosed systems can include reference receiver 610 configured to receive a reference RF signal 612 directly from reference transmitter 10. In some embodiments, reference receiver 610 can be configured to receive reference RF signal 612 omnidirectionally, and in others be configured to have a reference directionality in receiving reference RF signal 612. The use of reference receiver 610 can provide information about the emissions from reference transmitter 10. For example, reference receiver 610 can provide improved estimates of transmission strength, phase, frequency, etc.

However, in embodiments where there is no reference receiver (e.g., as in FIG. 1), such embodiments can beneficially not be susceptible to self-jamming (e.g., first RF signal 112 from target 20 being swamped by the stronger first direct signal 12). By having multiple receivers that see the echo (but not necessarily the direct path), and also know their relative location to each other, the distance from the transmitter to the target can be calculated, thus leaving the relative distance from the target to the receivers.

In some embodiments, a system can include two or more RF receivers, each configured to receive an RF signal. The RF receivers can be configured to have a directionality for receiving the RF signal and time synchronized to a fraction of a wavelength with the other receivers. The synchronization can be performed by using a calibration routine and a multi-node two-way time transfer routine (for example, as disclosed in U.S. Patent Application Publication 2024-0340818 A1, published Oct. 10, 2024 and titled “TIME SYNCHRONIZATION IN SENSOR ARRAY SYSTEMS,” the contents of which are hereby incorporated by reference). The system can determine the location of a target by multi-lateration using a time or phase difference of arrival interferometry technique from the two or more RF receivers (for example as disclosed in U.S. Patent Application No. 18,866,895 filed Sep. 16, 2024 and titled “MULTILATERATION FOR GEOLOCATION OF TARGETS,” the contents of which are hereby incorporated by reference). The system can combine the determined time difference of arrival (TDOA) or phase difference of arrival (PDOA) from the two or more RF receivers to determine the target location in a manner similar to that discussed by the embodiments herein. In some embodiments, the fraction of a wavelength can be 1/100, 1/50, 1/20, 1/10, ⅕, ½, etc. In one example, time difference of arrival can have a source signal (e.g., echo) arriving at multiple receivers. The receivers can time stamp the arrival time of a signal. By comparing the different times that the signal arrives, and using the speed of light, the relative distances between the source (e.g., echo) and the receivers can be determined. This requires the clocks of the receivers to be more accurate than the required position accuracy. In another example, PDOA can be similar where instead of time stamping the signals arrival, the phase difference between the signals arrival can be calculated. Knowing the spatial distance between the receivers and the phase difference allows the angle of arrival to be calculated. This angle can then be used for biangulation or triangulation, combined with TDOA or another distance source for location, etc.

In the following, further features, characteristics, and exemplary technical solutions of the present disclosure will be described in terms of items that may be optionally claimed in any combination:
Clause 1. A system comprising: a first RF receiver configured to have a first directionality for receiving a first RF signal in a first spatial window that contains a target; a second RF receiver configured to have a second directionality for receiving a second RF signal in a second spatial window that also contains the target; at least one programmable processor; and a non-transitory machine-readable medium storing instructions which, when executed by the at least one programmable processor, cause the at least one programmable processor to perform operations comprising: determining an overlapping spatial window of the first spatial window and the second spatial window; and determining a location of the target within the overlapping spatial window based on a correlation that utilizes the first RF signal with a reduced time window based on the overlapping spatial window.
Clause 2. The system of clause 1, wherein the system includes at least 10 RF receivers, in addition to the first RF receiver and the second RF receiver, and the correlation is based on corresponding RF signals received at the at least 10 RF receivers.
Clause 3. The system of any one of the preceding clauses, wherein the first RF receiver and second RF receiver are connected via a communication network.
Clause 4. The system of any one of the preceding clauses, wherein the correlation is an autocorrelation between the first RF signal and a first direct signal from a reference transmitter, the correlation providing a correlation peak giving range data of the target from the first RF receiver and also a frequency shift of the correlation peak giving speed data of the target.
Clause 5. The system of any one of the preceding clauses, wherein the first spatial window and the second spatial window are based at least on a range, azimuth, or elevation.
Clause 6. The system of any one of the preceding clauses, the operations further comprising changing a first direction of the first RF receiver or a second direction of the second RF receiver to change the overlapping spatial window and sweep over a region of interest to generate multiple overlapping spatial windows.
Clause 7. The system of any one of the preceding clauses, the operations further comprising performing correlations in the multiple overlapping spatial windows to determine the location.
Clause 8. The system of any one of the preceding clauses, the operations further comprising performing parallel correlations for two or more of the multiple overlapping spatial windows.
Clause 9. The system of any one of the preceding clauses, the operations further comprising: determining an initial state of the target based on the first RF signal and the second RF signal, wherein the first RF signal and second RF signal used to determine the initial state are not localized to the overlapping spatial window; and determining a subsequent overlapping spatial window for a subsequent state of the target by excluding spatial information or frequency information from the first RF signal and the second RF signal that does not correspond to a window around the initial state of the target.
Clause 10. The system of any one of the preceding clauses, wherein the initial state includes an initial location of the target or an initial speed of the target and the window is at least based on a location window around the initial location or a speed window around the initial speed of the target.
Clause 11. The system of any one of the preceding clauses, wherein the first RF signal has encoded spatial information and frequency information, the operations further comprising: determining the spatial information and the frequency information of the first RF signal, where the frequency information includes a frequency shift based on a target speed; and excluding a portion of the spatial information based on the portion having frequency information outside a frequency window around the frequency shift, when determining the location of the target.
Clause 12. The system of any one of the preceding clauses, wherein the reduced time window is further based on a distance of the overlapping spatial window from the first RF receiver.
Clause 13. The system of any one of the preceding clauses, the operations further comprising determining a speed of the target based on a doppler shift of a frequency location of a correlation peak in the correlation.
Clause 14. The system of any one of the preceding clauses, the operations further comprising determining a range of the target based on a spatial location of a correlation peak in the correlation.
Clause 15. The system of any one of the preceding clauses, wherein an RF signal to the first RF receiver comprises a direct signal from a reference transmitter, the first RF signal reflected from the target, and a multipath signal resulting from other reflections of RF signals originating from the reference transmitter.
Clause 16. The system of any one of the preceding clauses, wherein the reduced time window reduces a contribution of the multipath signal to the correlation.
Clause 17. The system of any one of the preceding clauses, the operations further comprising filtering the first RF signal or the second RF signal with a finite impulse response (FIR) filter to reduce direct signal interference from a transmitter transmits a reference RF signal to the target that reflects to generate the first RF signal and the second RF signal.
Clause 18. The system of any one of the preceding clauses, wherein the FIR filter is a spatial filter.
Clause 19. The system of any one of the preceding clauses, wherein the FIR filter is a temporal filter.
Clause 20. The system of any one of the preceding clauses, the operations further comprising thumbtack autocorrelation.
Clause 21. The system of any one of the preceding clauses, the operations further comprising subtracting delayed replicas of the RF reference signal from the first RF signal and the second RF signal.
Clause 22. The system of any one of the preceding clauses, the operations further comprising matched filtering.
Clause 23. The system of any one of the preceding clauses, the operations further comprising remodulation of a reference signal.
Clause 24. The system of any one of the preceding clauses, further comprising a dedicated transmitter configured to transmit a dedicated RF signal to the target, with a reflected dedicated RF signal that is detected by the first RF receiver or the second RF receiver and increases an amplitude of the correlation.
Clause 25. The system of any one of the preceding clauses, further comprising a reference receiver configured to receive a reference RF signal directly from a reference transmitter that transmits the reference RF signal to the target that reflects to generate the first RF signal and the second RF signal.
Clause 26. The system of any one of the preceding clauses, wherein the reference receiver is configured to receive the reference RF signal omnidirectionally.
Clause 27. The system of any one of the preceding clauses, wherein the reference receiver is configured to have a reference directionality in receiving the reference RF signal.
Clause 28. A system comprising: two or more RF receivers, each configured to receive an RF signal, the RF receivers configured to have a directionality for receiving the RF signal and time synchronized to a fraction of a wavelength with the other receivers using a calibration routine and a multi-node two-way time transfer routine; at least one programmable processor; and a non-transitory machine-readable medium storing instructions which, when executed by the at least one programmable processor, cause the at least one programmable processor to perform operations comprising: determining a location of a target by multi-lateration using a time or phase difference of arrival interferometry technique from the two or more RF receivers.
Clause 29. The system of any one of the preceding system clauses, wherein the fraction is 1/10th of the wavelength or less.
Clause 30. The system of any one of the preceding system clauses, the operations further comprising combining the determined time difference or phase difference of arrival from the two or more RF receivers to determine the location.
Clause 31. A non-transitory, machine-readable medium storing instructions which, when executed by at least one programmable processor, cause the at least one programmable processor to perform operations comprising: receiving, from a first RF receiver having a first directionality, a first RF signal from a first spatial window that contains a target; receiving, from a second RF receiver having a second directionality, a second RF signal in a second spatial window that also contains the target; determining an overlapping spatial window of the first spatial window and the second spatial window; and determining a location of the target within the overlapping spatial window based on a correlation between first RF signal and the second RF signal, wherein the location is based on a correlation strength and known locations of the first RF receiver and the second RF receiver.
Clause 32. The machine-readable medium of clause 31, wherein the correlation is an autocorrelation between the first RF signal and a first direct signal from a reference transmitter, the operations further comprising: providing, with the autocorrelation, a correlation peak giving range data of the target from the first RF receiver and also a frequency shift of the correlation peak giving speed data of the target.
Clause 33. The machine-readable medium of any one of the preceding machine-readable medium clauses, the operations further comprising: changing a first direction of the first RF receiver or a second direction of the second RF receiver to change the overlapping spatial window and sweep over a region of interest to generate multiple overlapping spatial windows.
Clause 34. The machine-readable medium of any one of the preceding machine-readable medium clauses, the operations further comprising: determining an initial state of the target based on the first RF signal and the second RF signal, wherein the first RF signal and second RF signal used to determine the initial state are not localized to the overlapping spatial window; and determining a subsequent overlapping spatial window for a subsequent state of the target by excluding spatial information or frequency information from the first RF signal and the second RF signal that does not correspond to a window around the initial state of the target
Clause 35. The machine-readable medium of any one of the preceding machine-readable medium clauses, wherein the first RF signal has encoded spatial information and frequency information, the operations further comprising: determining the spatial information and the frequency information of the first RF signal, where the frequency information includes a frequency shift based on a target speed; and excluding a portion of the spatial information based on the portion having frequency information outside a frequency window around the frequency shift, when determining the location of the target.

The present disclosure contemplates that the calculations disclosed in the embodiments herein may be performed in a number of ways, applying the same concepts taught herein, and that such calculations are equivalent to the embodiments disclosed.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” (or “computer readable medium”) refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” (or “computer readable signal”) refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, computer programs and/or articles depending on the desired configuration. Any methods or the logic flows depicted in the accompanying figures and/or described herein do not necessarily require the particular order shown, or sequential order, to achieve desirable results. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. The implementations described above can be directed to various combinations and subcombinations of the disclosed features and/or combinations and subcombinations of further features noted above. Furthermore, above described advantages are not intended to limit the application of any issued claims to processes and structures accomplishing any or all of the advantages.

Additionally, section headings shall not limit or characterize the invention(s) set out in any claims that may issue from this disclosure. Further, the description of a technology in the “Background” is not to be construed as an admission that technology is prior art to any invention(s) in this disclosure. Neither is the “Summary” to be considered as a characterization of the invention(s) set forth in issued claims. Furthermore, any reference to this disclosure in general or use of the word “invention” in the singular is not intended to imply any limitation on the scope of the claims set forth below. Multiple inventions may be set forth according to the limitations of the multiple claims issuing from this disclosure, and such claims accordingly define the invention(s), and their equivalents, that are protected thereby.

What is claimed is:

1. A system comprising:
a first RF receiver configured to have a first directionality for receiving a first RF signal in a first spatial window that contains a target;
a second RF receiver configured to have a second directionality for receiving a second RF signal in a second spatial window that also contains the target;
at least one programmable processor; and
a non-transitory machine-readable medium storing instructions which, when executed by the at least one programmable processor, cause the at least one programmable processor to perform operations comprising:
determining an overlapping spatial window of the first spatial window and the second spatial window; and
determining a location of the target within the overlapping spatial window based on a correlation that utilizes the first RF signal with a reduced time window based on the overlapping spatial window.

2. The system of claim 1, wherein the system includes at least 10 RF receivers, in addition to the first RF receiver and the second RF receiver, and the correlation is based on corresponding RF signals received at the at least 10 RF receivers.

3. The system of claim 1, wherein the first RF receiver and second RF receiver are connected via a communication network.

4. The system of claim 1, wherein the correlation is an autocorrelation between the first RF signal and a first direct signal from a reference transmitter, the correlation providing a correlation peak giving range data of the target from the first RF receiver and also a frequency shift of the correlation peak giving speed data of the target.

5. The system of claim 1, wherein the first spatial window and the second spatial window are based at least on a range, azimuth, or elevation.

6. The system of claim 1, the operations further comprising changing a first direction of the first RF receiver or a second direction of the second RF receiver to change the overlapping spatial window and sweep over a region of interest to generate multiple overlapping spatial windows.

7. The system of claim 6, the operations further comprising performing correlations in the multiple overlapping spatial windows to determine the location.

8. The system of claim 6, the operations further comprising performing parallel correlations for two or more of the multiple overlapping spatial windows.

9. The system of claim 1, the operations further comprising:
determining an initial state of the target based on the first RF signal and the second RF signal, wherein the first RF signal and second RF signal used to determine the initial state are not localized to the overlapping spatial window; and
determining a subsequent overlapping spatial window for a subsequent state of the target by excluding spatial information or frequency information from the first RF signal and the second RF signal that does not correspond to a window around the initial state of the target.

10. The system of claim 9, wherein the initial state includes an initial location of the target or an initial speed of the target and the window is at least based on a location window around the initial location or a speed window around the initial speed of the target.

11. The system of claim 1, wherein the first RF signal has encoded spatial information and frequency information, the operations further comprising:
determining the spatial information and the frequency information of the first RF signal, where the frequency information includes a frequency shift based on a target speed; and
excluding a portion of the spatial information based on the portion having frequency information outside a frequency window around the frequency shift, when determining the location of the target.

12. The system of claim 1, wherein the reduced time window is further based on a distance of the overlapping spatial window from the first RF receiver.

13. The system of claim 1, the operations further comprising determining a speed of the target based on a doppler shift of a frequency location of a correlation peak in the correlation.

14. The system of claim 1, the operations further comprising determining a range of the target based on a spatial location of a correlation peak in the correlation.

15. The system of claim 1, wherein an RF signal to the first RF receiver comprises a direct signal from a reference transmitter, the first RF signal reflected from the target, and a multipath signal resulting from other reflections of RF signals originating from the reference transmitter.

16. The system of claim 15, wherein the reduced time window reduces a contribution of the multipath signal to the correlation.

17. The system of claim 1, the operations further comprising filtering the first RF signal or the second RF signal with a finite impulse response (FIR) filter to reduce direct signal interference from a transmitter transmits a reference RF signal to the target that reflects to generate the first RF signal and the second RF signal.

18. The system of claim 17, wherein the FIR filter is a spatial filter.

19. The system of claim 17, wherein the FIR filter is a temporal filter.

20. The system of claim 17, the operations further comprising thumbtack autocorrelation.

21. The system of claim 17, the operations further comprising subtracting delayed replicas of the RF reference signal from the first RF signal and the second RF signal.

22. The system of claim 17, the operations further comprising matched filtering.

23. The system of claim 17, the operations further comprising remodulation of a reference signal.

24. The system of claim 1, further comprising a dedicated transmitter configured to transmit a dedicated RF signal to the target, with a reflected dedicated RF signal that is detected by the first RF receiver or the second RF receiver and increases an amplitude of the correlation.

25. The system of claim 1, further comprising a reference receiver configured to receive a reference RF signal directly from a reference transmitter that transmits the reference RF signal to the target that reflects to generate the first RF signal and the second RF signal.

26. The system of claim 25, wherein the reference receiver is configured to receive the reference RF signal omnidirectionally.

27. The system of claim 25, wherein the reference receiver is configured to have a reference directionality in receiving the reference RF signal.

28. A system comprising:
two or more RF receivers, each configured to receive an RF signal, the RF receivers configured to have a directionality for receiving the RF signal and time synchronized to a fraction of a wavelength with the other receivers using a calibration routine and a multi-node two-way time transfer routine;
at least one programmable processor; and
a non-transitory machine-readable medium storing instructions which, when executed by the at least one programmable processor, cause the at least one programmable processor to perform operations comprising:
determining a location of a target by multi-lateration using a time or phase difference of arrival interferometry technique from the two or more RF receivers.

29. The system of claim 28, wherein the fraction is 1/10th of the wavelength or less.

30. The system of claim 28, the operations further comprising combining the determined time difference or phase difference of arrival from the two or more RF receivers to determine the location.

31. A non-transitory, machine-readable medium storing instructions which, when executed by at least one programmable processor, cause the at least one programmable processor to perform operations comprising:
receiving, from a first RF receiver having a first directionality, a first RF signal from a first spatial window that contains a target;
receiving, from a second RF receiver having a second directionality, a second RF signal in a second spatial window that also contains the target;
determining an overlapping spatial window of the first spatial window and the second spatial window; and
determining a location of the target within the overlapping spatial window based on a correlation between first RF signal and the second RF signal, wherein the location is based on a correlation strength and known locations of the first RF receiver and the second RF receiver.

32. The machine-readable medium of claim 31, wherein the correlation is an autocorrelation between the first RF signal and a first direct signal from a reference transmitter, the operations further comprising:
providing, with the autocorrelation, a correlation peak giving range data of the target from the first RF receiver and also a frequency shift of the correlation peak giving speed data of the target.

33. The machine-readable medium of claim 31, the operations further comprising:
changing a first direction of the first RF receiver or a second direction of the second RF receiver to change the overlapping spatial window and sweep over a region of interest to generate multiple overlapping spatial windows.

34. The machine-readable medium of claim 31, the operations further comprising:
determining an initial state of the target based on the first RF signal and the second RF signal, wherein the first RF signal and second RF signal used to determine the initial state are not localized to the overlapping spatial window; and
determining a subsequent overlapping spatial window for a subsequent state of the target by excluding spatial information or frequency information from the first RF signal and the second RF signal that does not correspond to a window around the initial state of the target.

35. The machine-readable medium of claim 31, wherein the first RF signal has encoded spatial information and frequency information, the operations further comprising:
determining the spatial information and the frequency information of the first RF signal, where the frequency information includes a frequency shift based on a target speed; and
excluding a portion of the spatial information based on the portion having frequency information outside a frequency window around the frequency shift, when determining the location of the target.
